(19) United States
(12) Patent Application Publication
(10) Pub. No.: US 2013/0097636 A1
(43) Pub. Date: Apr. 18, 2013

(54) METHOD AND APPARATUS FOR DISPLAYING PICTURES DURING IPTV CHANNEL SWITCHING

(71) Applicant: Huawei Technologies Co., Ltd., Shenzhen (CN)

(72) Inventor: Haibin Zhang, Shenzhen (CN)

(73) Assignee: Huawei Technologies Co., Ltd., Shenzhen (CN)

(21) Appl. No.: 13/708,321

(22) Filed: Dec. 7, 2012

Related U.S. Application Data
(63) Continuation of application No. PCT/CN2011/078145, filed on Aug. 9, 2011.

(51) Int. Cl. H04N 21/472

(52) U.S. Cl. CPC H04N 21/472
USPC 725/38

(57) ABSTRACT

The embodiments of the present invention provide a method and apparatus for displaying pictures during IPTV channel switching, and refer to the field of Internet Protocol Television. The method comprising: waiting to receive a channel switching command sent by a user; when the channel switching command is received, acquiring YUV signal values of a picture that is currently displayed; processing the YUV signal values to make the picture realize a predetermined dynamic effect, and playing the predetermined dynamic effect. Through realizing the technical solution of the present invention, many predetermined dynamic effects may be displayed during the time delay of IPTV channel switching, so that user's usage experience may be greatly improved.

### CROSS-REFERENCE TO RELATED APPLICATIONS

This application is a continuation of International Application No. PCT/CN2011/078145, filed on Aug. 9, 2011, which is hereby incorporated by reference in its entirety.

### TECHNICAL FIELD

The present invention refers to the field of Internet Protocol Television (IPTV), specially, refers to a method and apparatus for displaying pictures during IPTV channel switching.

### BACKGROUND

Internet Protocol Television (IPTV) technology improves human-machine interaction, and users are no longer merely passive recipients of information any more. For example, Telecast, provides a manner of instant broadcast of information, which is still a main source for the communities to receive the latest information. Therefore, the experience of the direct broadcast may affect the development of IPTV to a great degree.

Recently, channel switching of IPTV broadcast commonly has a delay of 1.3-1.8 s, during which, as a main processing manner, IPTV program is suspended on the current picture of the current video and starts to play the next video in the other channel until an I frame of the video to be switched to arrives, or IPTV program directly waits with a black screen and starts to play the next video in the other channel until an I frame of the video to be switched to arrives.

Presently, all vendors adopt the above manners to process IPTV channel switching, thus leading to tediousness in user experience during IPTV channel switching.

### SUMMARY

In order to improve user experience during IPTV channel switching, a method and an apparatus for displaying picture during IPTV channel switching are provided in embodiments of the present invention. The technical solutions are as follows.

A method for displaying pictures during IPTV channel switching, comprising:

waiting to receive a channel switching command sent by a user;

when the channel switching command is received, acquiring YUV signals of a picture that is currently displayed, wherein Y is a luminance signal of the picture, U is a red-biased chrominance signal of the picture, and V is a blue-biased chrominance signal of the picture;

processing the YUV signals in order to make the picture realize a predetermined dynamic effect and playing the picture in the dynamic effect, wherein the dynamic effect comprises page-flipping, scrolling, shuttering, or fading-in and fading-out.

An apparatus for displaying pictures during IPTV channel switching, comprising: a receiving module, an acquiring module, and a processing and playing module; wherein,

the receiving module is configured to wait to receive a channel switching command sent by a user;

the acquiring module is configured to, when the channel switching command is received by the receiving module, acquire YUV signals values of a picture that are currently displayed, Y is a luminance signal of the picture, U is a red-biased chrominance signal of the picture, and V is a blue-biased chrominance signal of the picture;

the processing and playing module for processing the YUV signals acquired by the acquiring module in order to make the picture realize a predetermined dynamic effect, and playing the picture in the dynamic effect, wherein the dynamic effect comprises page-flipping, scrolling, shuttering, or fading-in and fading-out.

The embodiments of the present invention have the following beneficial effects: through acquiring YUV signals of a picture that are currently displayed when a channel switching command is received, processing the YUV signals values to make the picture realize a predetermined dynamic effect, and playing the picture in the dynamic effect, many dynamic effects, such as page-flipping, scrolling, shuttering, or fading-in and fading-out may be displayed during the delay of IPTV channel switching, which greatly improves user's experience, and will further increase adherence of users with a product and improve the market competitiveness of the product such as IPTV set-top box.

### BRIEF DESCRIPTION OF THE DRAWINGS

For a explicit description of technical solutions of embodiments of the present invention, a brief introduction of accompanying drawings to be used in the description of these embodiments will be given below. Obviously, accompanying drawings described below are merely some embodiments of the present invention, for those skilled in the art, other accompanying drawings may be derived from these ones without any creative efforts.

FIG. 1 is a flowchart of a method for displaying picture during IPTV channel switching provided in embodiment 1 of the present invention;

FIG. 2 is a flowchart of a method for displaying picture during IPTV channel switching provided in embodiment 2 of the present invention;

FIG. 3 is a block diagram of an apparatus for displaying picture during IPTV channel switching provided in embodiment 3 of the present invention.

### DETAILED DESCRIPTION OF THE PREFERRED EMBODIMENT

For a better clarity of objects, technical solutions, and advantages of the embodiments of the present invention, a clear and complete description of technical solutions of embodiments of the present invention will be given in connection with the accompanying drawings on the exemplary embodiments.

### Embodiment 1

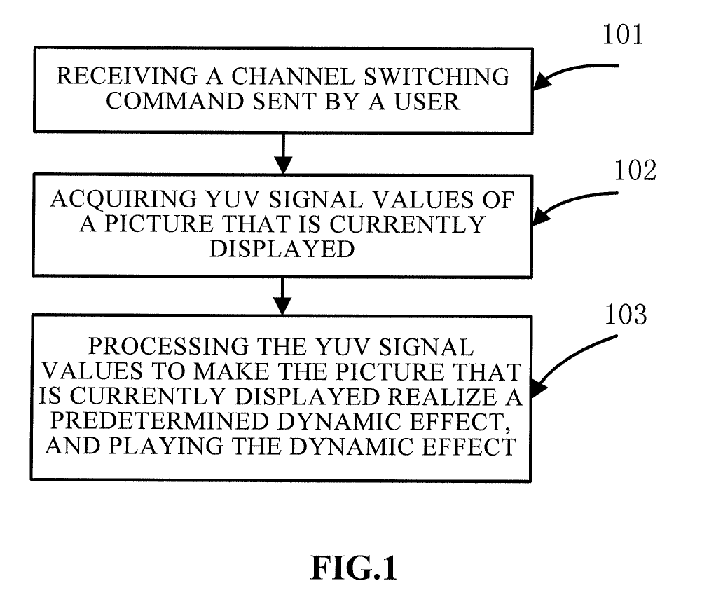

Referring to FIG. 1, a method for displaying picture during IPTV channel switching is provided, which in particular including the following steps.

Step 101: receive a channel switching command sent by a user.

Step 102: acquire YUV signal values of a picture that is currently displayed, wherein Y is a luminance signal of the picture, U is a red-biased chrominance signal of the picture, and V is a blue-biased chrominance signal of the picture.

Step 103: process the YUV signal values to make the picture realize a predetermined dynamic effect, and the dynamic effect is played, wherein the dynamic effect comprising page-flipping, scrolling, shuttering, or fading-in and fading-out.

This embodiment of the present invention has the following beneficial effects: through acquiring YUV signal values of a picture that is currently displayed, and processing the YUV signal values to make the picture realize a predetermined dynamic effect, and playing the dynamic effect, many predetermined dynamic effects, such as page-flipping, scrolling, shuttering, or fading-in and fading-out may be displayed during the time delay of IPTV channel switching, which greatly enhance user's usage experience, and will further increase adherence of users with a product and improve the market competitiveness of the product such as IPTV set-top boxes.

### Embodiment 2

Firstly, a system architecture corresponding to this embodiment will be introduced, the system architecture comprises a camera, a transmitting end and a receiving end, wherein the camera is used to take scene image; the transmitting end is used to transmit the image taken by the camera to the receiving end; the receiving end is used to play various images received. In existing color TV systems, tricolor cameras or color CCD (charge coupled device) cameras are commonly employed to take image of scenes, then after color separation of color images that have been taken, each color is amplified and corrected respectively to obtain RGB data (that is because under the present RGB color model, each color may have one RGB data representation, e.g., bright red may be represented by R value of 255, G value of 0 and B value of 0); after that, the obtained RGB data is transformed into a Y luminance signal and two chrominance signals U and V by a matrix transforming circuit; the transmitting side (for example, a television tower) encodes the luminance signal and the chrominance signals respectively, and sends them on the same channel to the receiving side (for example, IPTV); the receiving side decodes the received code stream and displays it for the user.

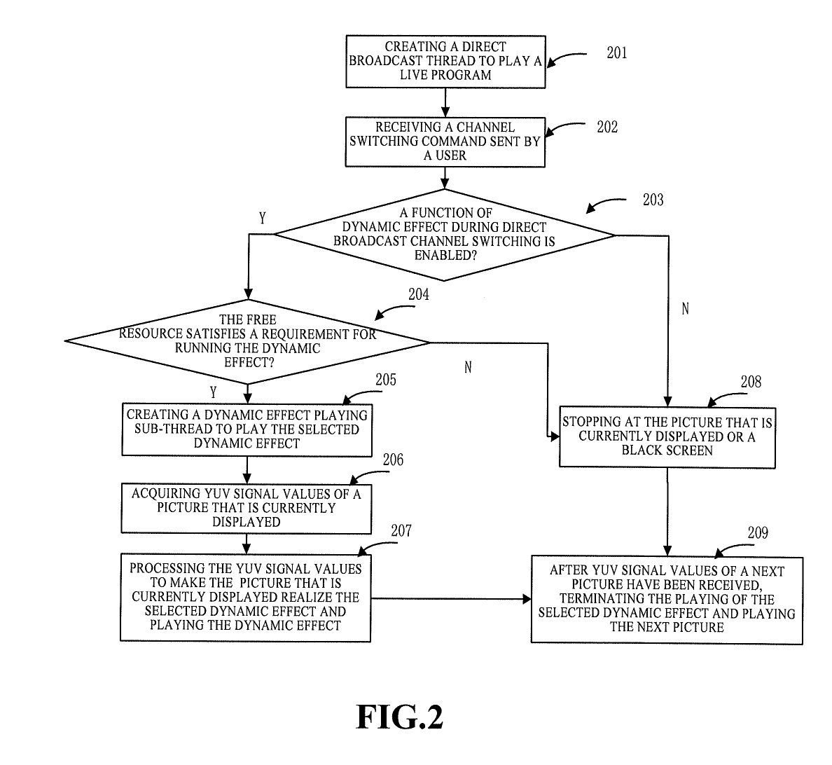

Referring to FIG. 2, a method for displaying pictures during IPTV channel switching, which may also be executed by an executive subject which is the same as an IPTV set-top box, in particular comprises the following steps.

Step 201: create a direct broadcast thread to play a live program.

In particular, a user may enter a direct broadcast control page by operating a remote control, select a live program from the direct broadcast control page, send a request for playing the selected live program to an IPTV set-box, which may create a direct broadcast thread to play the live program requested by the user after receiving the request.

Step 202: receive a channel switching command sent by the user.

Step 203: determine whether a function of dynamic effect during direct broadcast channel switching is enabled, if the function of dynamic effect during direct broadcast channel switching is enabled, a step 204 is executed; otherwise, if the function of dynamic effect during direct broadcast channel switching is disabled, a step 208 is executed.

Preferably, a dynamic effect identifier is detected. When the dynamic effect identifier is set to a predetermined value (such as 1), the function of dynamic effect during direct broadcast channel switching is enabled; otherwise, if the dynamic effect identifier is not the predetermined value (such as 0), the function of predetermined dynamic effect during direct broadcast channel switching is disabled.

Wherein, the dynamic effect identifier is preset by the vendor of the set-top box when it is delivered.

In addition, users may freely select whether to enable predetermined dynamic effects during direct broadcast channel switching, and send a command of enabling or disabling dynamic effects during direct broadcast channel switching to the IPTV set-top box; the IPTV set-top box enables or disables the function of predetermined dynamic effects during direct broadcast channel switching according to the received command.

For example, a user may select whether to enable the function of predetermined dynamic effects during direct broadcast channel switching by operating a remote control, and send a command of enabling or disabling the function of predetermined dynamic effects during direct broadcast channel switching to the IPTV set-top box.

At step 204, a dynamic effect is selected. Herein, the IPTV set-top box selects a predetermined dynamic effect for the user randomly, and determines whether the free resource of its CPU (central processing unit) satisfies a service requirement for running the selected predetermined dynamic effect.

If the free CPU resource satisfies the service requirement for running the selected predetermined dynamic effect, a step 205 is executed.

If the free CPU resource does not satisfy the service requirement for running the selected predetermined dynamic effect, a step 208 is executed.

In particular, the size of the current free CPU resource is compared with the resource size required by the selected predetermined dynamic effect, and when the free resource is not less than the resource that is required to run the selected predetermined dynamic effect, the CPU resource satisfies the service requirement for running the selected predetermined dynamic effect; otherwise, the CPU resource does not satisfy the service requirement for running the selected predetermined dynamic effect.

Wherein, the predetermined dynamic effect comprising: page-flipping, scrolling, shuttering, or fading-in and fading-out.

At step 205, a predetermined dynamic effect playing sub-thread is created to play the selected dynamic effect.

At step 206, acquire YUV signal values of a picture that is currently displayed, wherein Y is a luminance signal of the picture, U is a red-biased chrominance signal of the picture, and V is a blue-biased chrominance signal of the picture.

In particular, the user may send a channel switching request for switching a current live program to another live program to the IPTV set-top box by operating a remote control; when receiving the channel switching request, the IPTV set-top box acquires code stream of the picture that is currently displayed from a playing buffer, and parses the acquired code stream to obtain YUV signal values of the picture that is currently displayed.

At step 207, process the obtained YUV signal values to make the picture that is currently displayed realize the selected dynamic effect, and the dynamic effect is played, followed by a step 209.

In particular, this step may display through the following two manners.

The manner 1 in particular comprises the following operations:

Step 207-1: convert the YUV signal values into data in RGB format, wherein R is the value of red, G is the value of green, and B is the value of blue.

In particular, the obtained YUV signal values are converted into the data in RGB format according to preset equations, wherein the preset equations are:

Y=floor(2^{M-8}*(219*(L−Z)/S+16)+0.5);

U=clip3(0,2^{M-1},floor(2^{M-8}*(112*(B−L)/((1−Kb)*S)+128)+0.5));

V=clip3(0,2^{M-1},floor(2^{M-8}*(112*(R−L)/((1−Kr)*S)+128)+0.5));

L=Kr*R+Kb*B+(1−Kr−Kb)*G;

wherein, Kr and Kb are two constants, Kr=0.2126 Kb=0.0722, or Kr=0.299 Kb=0.114;

M is the number of the bits of a YUV signal value, and generally M>=8;

Z is a black level variable, and generally Z is set to 0 or 16*2;

S is a scaling variable, and generally is set to 255 or 219*2.

At step 207-2: fill the data in RGB format into a predetermined memory area “surface”.

At step 207-3: in the memory area “surface”, process the data in RGB format to obtain picture data of one picture having the predetermined dynamic effect and a process number is increased by 1, wherein the process number has an original value of 0.

Wherein, processing the data in RGB format to obtain the picture data of one picture having the predetermined dynamic effect comprises:

dividing the data in RGB format into several data blocks; processing the data in RGB format in part of the data blocks, including multiplying the data in RGB format in part of the data blocks with a predetermined scaling coefficient, filling them with a transparent color, performing compression or symmetrical transform on them, and the processed data in part of the data blocks and unprocessed data in part of the data blocks construct the frame data of one picture having the predetermined dynamic effect.

At step 207-4: determine whether the process number reaches a predetermined threshold.

At step 207-5, when the process number is not greater than the predetermined threshold, copy the picture frame data to a display layer area “framebuffer” for display, and returns to step 207-3, until the process number is greater than the predetermined threshold.

Now, the process of steps 207-3 to 207-5 will be described with an example.

Herein, when the selected predetermined dynamic effect is up-and-down shuttering and the height of the IPTV screen is 500 pixels, the IPTV screen is divided into 5 blocks from top to bottom equally, each block is 100 pixels in height, and the process number is 10.

In the memory area “surface”, one tenth of the data of each data block of 100 pixels high is filled with a transparent color, then respective processed data blocks are moved as a whole to the display layer area “framebuffer” to display, and such process is repeated by 10 times to realize the predetermined dynamic effect of up-and-down shuttering.

As a second manner, an API corresponding to a predetermined dynamic effect is obtained through searching a predetermined dynamic effect database.

The YUV signal values are processed through invoking the API to make the picture realize the predetermined dynamic effect, and the predetermined dynamic effect is played.

Herein, methods for implementing various predetermined dynamic effects are encapsulated as API interfaces and stored in a dynamic effect database in advance. As such, it is only needed to invoke a corresponding API when a certain predetermined dynamic effect is to be realized on a display screen by an IPTV set-top box, such that the realization of predetermined dynamic effect is more convenient and more effective.

At step 208, the picture that is currently displayed is stopped at or a black screen is displayed.

At step 209, after receiving picture data of a next picture, terminate the playing of the selected predetermined dynamic effect, and play the next picture.

The embodiment of the present invention has the following beneficial effects: through realizing a technical solution of acquiring YUV signal values of a picture that is currently displayed when receiving a channel switching command, processing the YUV signal values to make the picture realize a predetermined dynamic effect and playing the predetermined dynamic effect, many dynamic effects, such as page-flipping, scrolling, shuttering, or fading-in and fading-out, may be displayed during the time delay of IPTV channel switching, which greatly enhances user's usage experience, and will further increase adherence of users with the product and improve the market competitiveness of the products such as IPTV set-top box.

### Embodiment 3

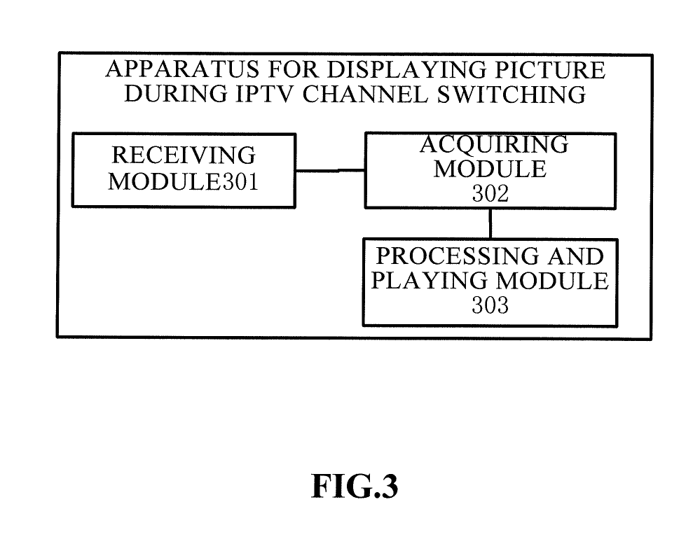

Referring to FIG. 3, an apparatus for displaying pictures during IPTV channel switching is provided, which is in particular the set-top box of the method embodiment and comprises: a receiving module 301, an acquiring module 302 and a processing and playing module 303; wherein,

the receiving module 301 is used to wait to receive a channel switching command sent by a user;

the acquiring module 302 is used to, when the channel switching command is received by the receiving module 301, acquire YUV signal values of a picture that is currently displayed, Y is a luminance signal of the picture, U is a red-biased chrominance signal of the picture, and V is a blue-biased chrominance signal of the picture;

the processing and playing module 303 is used to process the YUV signal values acquired by the acquiring module 302 to make the picture that is currently displayed realize a predetermined dynamic effect and play the dynamic effect, the predetermined dynamic effect comprising page-flipping, scrolling, shuttering, or fading-in and fading-out.

In particular, the processing and playing module 303 comprises:

a format conversion unit, which is used to convert the YUV signal values into data in RGB format, wherein R is the value of red, G is the value of green, and B is the value of blue;

a filling unit, which is used to fill the data in RGB format converted by the format conversion unit into a predetermined memory area;

a processing unit, which is used to, in the predetermined memory area, process the data in RGB format to obtain frame data of one picture having the predetermined dynamic effect, and increase a process number by 1, wherein the process number has an original value of 0;

a judging unit, which is used to judge whether the process number has reached a predetermined threshold;

a playing unit, which is used to, when the judging unit judges that the process number is not greater than the predetermined threshold, copy the frame data obtained by the processing unit to a display layer area to display, and notify the processing unit to perform the operation of, in the memory area, processing the data in RGB format to obtain frame data of one picture having the predetermined dynamic effect, and increasing a process number by 1, until the process number is larger than the predetermined threshold.

Wherein, the processing unit comprises:

a block-dividing sub-unit, which is used to divide the data in RGB format into several data blocks;

a filling sub-unit, which is used to process the data in RGB format in part of the data blocks, comprising: multiplying the data in RGB format in part of the data blocks with a predetermined scaling coefficient, filling them with a transparent color, performing compression or symmetrical transform on them, and the processed data in part of the data blocks and unprocessed data in part of the data blocks construct the frame data of one picture having the dynamic effect.

The processing and playing module 303 further comprises:

a searching unit, which is used to search a dynamic effect database to obtain an API corresponding to the predetermined dynamic effect;

a processing and playing unit, which is used to invoke the API obtained by the searching unit to process the YUV signal values to make the picture realize the predetermined dynamic effect, and play the predetermined dynamic effect.

The apparatus further comprises a processing module, which is used to, after YUV signal values of a next picture are received, terminate the playing of the predetermined dynamic effect and play the next picture.

The embodiment of the present invention has the following beneficial effects: through realizing a technical solution of acquiring YUV signal values of a picture that is currently displayed when receiving a channel switching command, processing the YUV signal values to make the picture realize a predetermined dynamic effect and playing the dynamic effect, many dynamic effects, such as page-flipping, scrolling, shuttering, or fading-in and fading-out, may be displayed during the time delay of IPTV channel switching, which greatly enhances user's usage experience, and will further increase adherence of users with the product and improve the market competitiveness of the products such as IPTV set-top box.

Those skilled in the art may appreciate that all or some steps of the above embodiments may be implemented in hardware, or may be implemented by the related hardware instructed by a program, the program may be stored in a computer readable storage medium, which may comprise read-only memory, magnetic disk, or optical disk, etc.

The above description is merely some preferred embodiments of the present invention, and is not used to limit the present invention, any modifications, equivalent alternatives, and improvements within the spirit and principle of the present invention are encompassed in the scope of the present invention.

What is claimed is:

1. A method for displaying pictures during IPTV channel switching, comprising:
receiving a channel switching command sent by a user;
acquiring YUV signal values of a picture that is currently displayed, wherein Y is a luminance signal of the picture, U is a red-biased chrominance signal of the picture, and V is a blue-biased chrominance signal of the picture; and
processing the YUV signal values to make the picture realize a predetermined dynamic effect and playing the predetermined dynamic effect, wherein the predetermined dynamic effect comprising page-flipping, scrolling, shuttering, or fading-in and fading-out.

2. The method according to claim 1, wherein the processing of the YUV signal values to make the picture realize a predetermined dynamic effect and playing the predetermined dynamic effect comprising:
converting the YUV signal values into data in RGB format, wherein R is the value of red, G is the value of green, and B is the value of blue;
filling the data in RGB format into a predetermined memory area;
processing the data in RGB format to obtain picture data of one picture having the predetermined dynamic effect in the predetermined memory area, and increasing a process number by 1, wherein the process number has an original value of 0;
judging whether the process number has reached a predetermined threshold;
if the process number is not larger than the predetermined threshold, copying the frame data to a display layer area for display, and returning to repeat performing the operation in the predetermined memory area, processing the data in RGB format to obtain the picture data of the one picture having the predetermined dynamic effect, and increasing the process number by 1, until the process number is larger than the predetermined threshold.

3. The method according to claim 2, wherein the processing of the data in RGB format comprising:
dividing the data in RGB format into several data blocks;
processing the data in RGB format in a part of the data blocks, the processing comprising: multiplying the data in RGB format in the part of the data blocks with a predetermined scaling coefficient, filling the part of the data blocks with a transparent color and performing compression or symmetrical transform on the part of the data blocks, such that the processed data in the part of the data blocks and unprocessed data in the part of the data blocks construct the picture data of the one picture having the predetermined dynamic effect.

4. The method according to claim 1, wherein the processing of the YUV signal values to make the picture realize a predetermined dynamic effect and playing the predetermined dynamic effect comprising:
searching a predetermined dynamic effect database to obtain an API corresponding to the predetermined dynamic effect;
invoking the API to process the YUV signal values to make the picture realize the predetermined dynamic effect and the playing of the predetermined dynamic effect.

5. The method according to claim 1, the method further comprising: after YUV signal values of a next picture have been received, terminating the playing of the predetermined dynamic effect and playing the next picture.

6. An apparatus for displaying pictures during IPTV channel switching, comprises: a receiving module, an acquiring module, and a processing and playing module; wherein:
the receiving module configured to wait and to receive a channel switching command sent by a user;
the acquiring module configured to, when the channel switching command is received by the receiving module, acquire YUV signal values of a picture that is currently being displayed, wherein Y is a luminance signal of the picture, U is a red-biased chrominance signal of the picture, and V is a blue-biased chrominance signal of the picture;
the processing and playing module configured to process the YUV signal values acquired by the acquiring module to make the picture realize a predetermined dynamic effect and play the predetermined dynamic effect, wherein the predetermined dynamic effect comprising page-flipping, scrolling, shuttering, or fading-in and fading-out.

7. The apparatus according to claim 6, wherein the processing and playing module comprises:
a format conversion unit configured to convert the YUV signal values into data in RGB format, wherein R is the value of red, G is the value of green, and B is the value of blue;
a filling unit configured to fill the data in RGB format converted by the format conversion unit into a predetermined memory area;
a processing unit configured to, in the predetermined memory area, process the data in RGB format to obtain frame data of one picture having the predetermined dynamic effect, and increase a process number by 1, wherein the process number has an original value of 0;
a judging unit configured to judge whether the process number has reached a predetermined threshold;
a playing unit configured to, if the judging unit judges that the process number is not larger than the predetermined threshold, copy the frame data obtained by the processing unit into a display layer area for display, and notify the processing unit to perform the operation of, in the predetermined memory area, processing the data in RGB format to obtain picture data of one picture having the predetermined dynamic effect, and increasing a process number by 1, until the process number is larger than the predetermined threshold.

8. The apparatus according to claim 7, the processing unit comprises:
a block-dividing sub-unit configured to divide the data in RGB format into several data blocks;
a filling sub-unit configured to process the data in RGB format in part of the data blocks by: multiplying the data in RGB format in the part of the data blocks with a predetermined scaling coefficient, filling them with a transparent color, performing compression or symmetrical transform on the part of the data blocks, and the processed data in the part of the data blocks and unprocessed data in the part of the data blocks construct the frame data of one picture having the predetermined dynamic effect.

9. The apparatus according to claim 6, the processing and playing module comprises:
a searching unit configured to search a dynamic effect database to obtain an API corresponding to the predetermined dynamic effect,
a processing and playing unit configured to invoke the API obtained by the searching unit to process the YUV signal values to make the picture realize the predetermined dynamic effect, and play the predetermined dynamic effect.

10. The apparatus according to claim 6, the apparatus further comprises: a processing module configured to, after YUV signal values of a next picture have been received, terminate the playing of the predetermined dynamic effect and start to play the next picture.
